(19) United States
(12) Patent Application Publication
(10) Pub. No.: US 2026/0077751 A1
(43) Pub. Date: Mar. 19, 2026

(54) REMOTE RESERVOIR AND METHOD OF MOUNTING THE SAME

(71) Applicant: HL MANDO CORPORATION, Pyeongtaek-si (KR)

(72) Inventor: Seunghwan BYUN, Pyeongtaek-si (KR)

(73) Assignee: HL MANDO CORPORATION, Pyeongtaek-si (KR)

(21) Appl. No.: 18/967,785

(22) Filed: Dec. 4, 2024

(30) Foreign Application Priority Data
Sep. 13, 2024 (KR) 10-2024-0125843

(51) Int. Cl. B60T 11/26

(52) U.S. Cl. CPC B60T 11/26

(57) ABSTRACT

A remote reservoir according to an embodiment of the disclosed disclosure may be mounted on a structure of a vehicle and include a reservoir body having a chamber configured to store brake oil therein, an oil injection part provided at an upper front side of the reservoir body and configured to inject the brake oil, a connection port provided on the reservoir body and configured to supply the brake oil to a main reservoir provided to be spaced apart from the reservoir body, and a mounting part coupled to the structure of the vehicle, in which the mounting part includes a main mounting part configured to mount the reservoir body on the structure of the vehicle, and an auxiliary mounting part configured to mount the reservoir body on the structure of the vehicle before the main mounting part is coupled.

### CROSS-REFERENCE TO RELATED APPLICATIONS

This application claims the priority of Korean Patent Application No. 10-2024-0125843 filed on Sep. 13, 2024, in the Korean Intellectual Property Office, the disclosure of which is incorporated herein by reference.

### BACKGROUND

### Field

The disclosed disclosure relates to a remote reservoir and a method of mounting the same, and more particularly, to a remote reservoir, which may be separated from a brake module, mounted on a vehicle body, and temporarily coupled when being mounted, and a method of mounting the same.

### Description of the Related Art

A vehicle is essentially equipped with a brake system for braking the vehicle. Various types of brake systems have been proposed to provide safety for a driver and a passenger.

The brake system in the related art mainly operates in such a way that when the driver pushes a brake pedal, a booster mechanically connected to the brake pedal is used to supply a wheel cylinder with a liquid pressure required to brake the vehicle. However, as there is an increasing demand from the market to implement various braking functions in order to appropriately cope with operational environments of vehicles, integrated dynamic brakes (IDBs) have recently widely proliferated, in which when a driver pushes a brake pedal, a pedal displacement sensor, which detects a displacement of the brake pedal, transmits an electrical signal to indicate a driver's intention to brake, and a liquid pressure supply device operates in response to the electrical signal to supply a wheel cylinder with a liquid pressure required to brake the vehicle.

An integrated brake system may generate a stable, strong braking force by integrating a master booster and an electronic stability control (ESC) device. In general, the integrated brake system includes a configuration in which a pedal displacement sensor operates a motor by outputting an operation of a brake pedal as an electrical signal, a piston pump of a liquid pressure generation device generates hydraulic braking pressure in accordance with an operation of the motor, and an electronic control unit controls the hydraulic pressure and transmits the hydraulic pressure to wheels. In addition, a master cylinder is provided in a hydraulic block equipped with a hydraulic circuit to transmit a pedal effort of a brake pedal directly to a wheel cylinder when the system operates abnormally.

There is provided a reservoir that provides a pressing medium, such as brake oil, to the integrated brake system to perform a braking operation by means of the integrated brake system described above. Typically, the reservoir stores the pressing medium therein and is coupled to an upper portion of the master cylinder. In addition, the reservoir may be connected to the piston pump so that the piston pump provided in the liquid pressure generation device of the integrated brake system generates liquid pressure.

The reservoir is installed in various ways to supply the pressing medium to the integrated brake system. However, there is a problem in that it is difficult to install the reservoir in a limited space in the vehicle.

There has been developed a technology in which a size of a main reservoir connected directly to a master cylinder is reduced, and a remote reservoir is connected to the main reservoir by a connection member, such that a storage capacity of a pressing medium is ensured, and the remote reservoir is easily installed in a limited space. However, an operator couples the remote reservoir by using bolts and nuts to fix and install the remote reservoir in the vehicle. In this case, one operator fixes the remote reservoir to a coupling position, and another operator fastens the bolt and the nut, such that at least two operators are required.

### SUMMARY

An object to be achieved by the present embodiment is to provide a remote reservoir, which may be separated from a brake module, mounted on a vehicle body, and temporarily coupled when being mounted, and a method of mounting the same.

One aspect of the present disclosure provides a remote reservoir, which is mounted on a structure of a vehicle, the remote reservoir including: a reservoir body having a chamber configured to store brake oil therein; an oil injection part provided at an upper front side of the reservoir body and configured to inject the brake oil; a connection port provided on the reservoir body and configured to supply the brake oil to a main reservoir provided to be spaced apart from the reservoir body; and a mounting part coupled to the structure of the vehicle, in which the mounting part includes: a main mounting part configured to mount the reservoir body on the structure of the vehicle; and an auxiliary mounting part configured to mount the reservoir body on the structure of the vehicle before the main mounting part is coupled.

The main mounting part may be coupled to the structure of the vehicle by bolting.

The main mounting part may include: a first body protruding upward from an upper surface of the reservoir body and elongated in a leftward/rightward direction; and a main coupling portion provided on the first body.

The main mounting part may be coupled to a vertical wall portion of the structure of the vehicle.

The auxiliary mounting part may be coupled to a horizontal wall portion of the structure of the vehicle.

The auxiliary mounting part may include: a second body having a column shape, protruding upward from the upper surface of the reservoir body, and provided rearward of the first body; and mounting grooves recessed in two opposite surfaces of the second body, and the mounting grooves may be coupled to a first mounting hole provided in the horizontal wall portion.

The first mounting hole may include: a large width portion provided in the horizontal wall portion and larger than a cross-section of the second body; and a small width portion provided at a rear side of the large width portion, configured to communicate with the large width portion, and having a width smaller than a width of the large width portion, and the mounting grooves may be coupled by being slid from the large width portion toward the small width portion.

The second body may include a hole structure recessed downward from an upper surface of the second body.

The structure of the vehicle may include at least one bolt hole provided in the vertical wall portion, and the main mounting part may be coupled to the structure of the vehicle by a bolt penetratively coupled to the main coupling portion of the first body and the bolt hole of the vertical wall portion, and a nut coupled to the bolt.

The first body may be coupled to a front side of the vertical wall portion.

The auxiliary mounting part may include a coupling protrusion protruding rearward from the first body.

The first body may have a structure reinforcement portion provided between the upper surface of the reservoir body and a front surface of the first body and provided at a position corresponding to a position of the coupling protrusion.

The coupling protrusion may be inserted and coupled into a second mounting hole provided in the vertical wall portion.

The coupling protrusion may be inserted into the second mounting hole from a front surface thereof.

The auxiliary mounting part may include a coupling protrusion protruding rearward from the first body.

The coupling protrusion may be inserted and coupled into a second mounting hole provided in the vertical wall portion.

The coupling protrusion may be inserted into the second mounting hole from a front surface thereof.

Another aspect of the present disclosure provides a method of mounting a remote reservoir to be mounted on a structure of a vehicle, the method including: coupling a reservoir body, which has a chamber configured to store brake oil therein, to the structure of the vehicle by using an auxiliary mounting part of the remote reservoir; and coupling the reservoir body to the structure of the vehicle by using a main mounting part of the remote reservoir, in which the coupling of the reservoir body to the structure of the vehicle by using the main mounting part includes: penetratively coupling a bolt to a bolt hole of a vertical wall portion of the structure of the vehicle and a main coupling portion provided on a first body protruding upward from an upper surface of the reservoir body and elongated in a leftward/rightward direction; and coupling a nut to the bolt.

The coupling of the reservoir body to the structure of the vehicle by using the auxiliary mounting part may include: inserting a second body, which has a column shape, protrudes upward from the upper surface of the reservoir body, and provided rearward of the first body, into a large width portion of a first mounting hole provided in a horizontal wall portion of the structure of the vehicle; and coupling and sliding mounting grooves, which are recessed in two opposite surfaces of the second body, toward a small width portion formed at a rear side of the large width portion, configured to communicate with the large width portion, and having a width smaller than a width of the large width portion.

The coupling of the reservoir body to the structure of the vehicle by using the auxiliary mounting part may further include: inserting a coupling protrusion, which protrudes rearward from the first body, into a second mounting hole provided in the vertical wall portion when the mounting grooves are slid toward the small width portion.

According to the remote reservoir and the method of mounting the same according to the present embodiment, the remote reservoir may be temporarily coupled when being mounted, such that a single operator may mount the remote reservoir on the vehicle body.

According to the remote reservoir and the method of mounting the same according to the present embodiment, the remote reservoir is mounted on the vehicle body by means of the main mounting part and the auxiliary mounting part, such that the vibration durability may be improved.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view schematically illustrating a remote reservoir according to a first embodiment of the present disclosure;

FIG. 2 is a perspective view schematically illustrating a vehicle structure on which the remote reservoir and a reservoir according to the first embodiment of the present disclosure are mounted;

FIG. 3 is a side view schematically illustrating a state in which the remote reservoir according to the first embodiment of the present disclosure is coupled to the vehicle structure;

FIG. 4 is a top plan view schematically illustrating a state in which the remote reservoir according to the first embodiment of the present disclosure is coupled to the vehicle structure;

FIG. 5 is a perspective view schematically illustrating a remote reservoir according to a second embodiment of the present disclosure;

FIG. 6 is a side view schematically illustrating a state in which the remote reservoir according to the second embodiment of the present disclosure is coupled to the vehicle structure;

FIG. 7 is a top plan view schematically illustrating a state in which the remote reservoir according to the second embodiment of the present disclosure is coupled to the vehicle structure;

FIG. 8 is a perspective view schematically illustrating a remote reservoir according to a third embodiment of the present disclosure;

FIG. 9 is a top plan view schematically illustrating a state in which the remote reservoir according to the third embodiment of the present disclosure is coupled to the vehicle structure;

FIG. 10 is a side view schematically illustrating a process of coupling the remote reservoir according to the third embodiment of the present disclosure to the vehicle structure; and

FIG. 11 is a side view schematically illustrating a state in which the remote reservoir according to the third embodiment of the present disclosure is coupled to the vehicle structure.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Hereinafter, embodiments of the present disclosure will be described in detail with reference to the accompanying drawings. The following embodiments are presented to sufficiently provide the spirit of the present disclosure to those skilled in the art to which the present disclosure pertains. The present disclosure is not limited to the embodiments presented herein and may be specified as other aspects. The constituent elements irrelevant to the description of the present disclosure will be omitted from the drawings to clearly describe the present disclosure. The sizes of the constituent elements may be somewhat exaggerated for purposes of understanding.

Hereinafter, operation principles and embodiments of the disclosed disclosure will be described in detail with reference to the accompanying drawings.

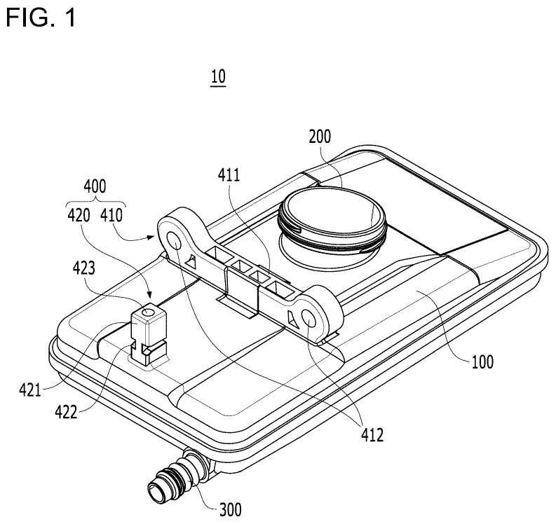

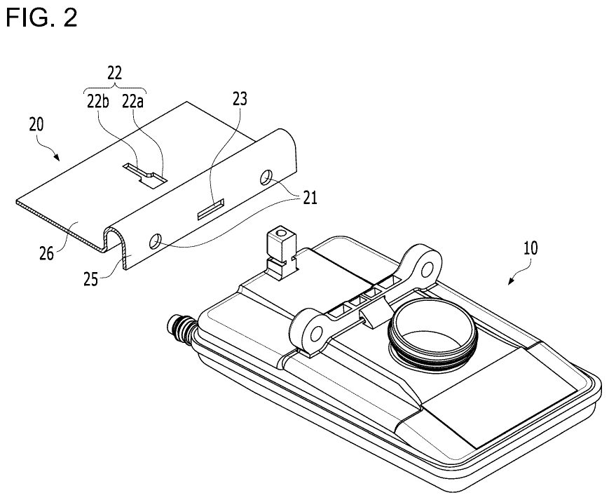

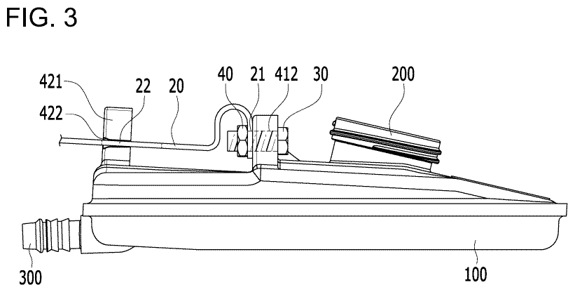

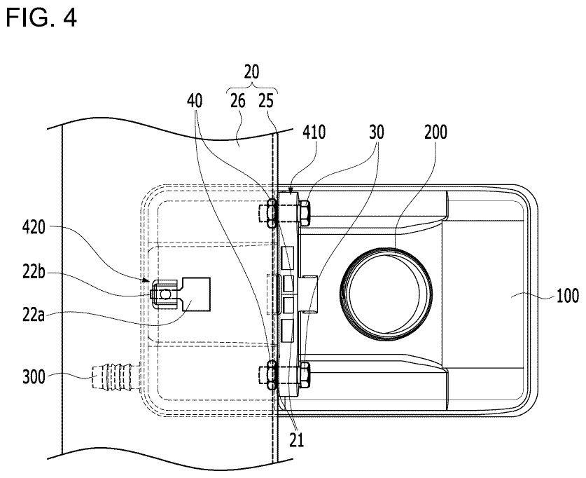

FIG. 1 is a perspective view schematically illustrating a remote reservoir according to a first embodiment of the present disclosure, FIG. 2 is a perspective view schematically illustrating a vehicle structure on which the remote reservoir and a reservoir according to the first embodiment of the present disclosure are mounted, FIG. 3 is a side view schematically illustrating a state in which the remote reservoir according to the first embodiment of the present disclosure is coupled to the vehicle structure, and FIG. 4 is a top plan view schematically illustrating a state in which the remote reservoir according to the first embodiment of the present disclosure is coupled to the vehicle structure.

A remote reservoir 10 of the present disclosure is mounted directly on a structure 20 of a vehicle. In order to provide brake oil to a brake system, the remote reservoir 10 may be connected to a main reservoir mounted on a master cylinder or a hydraulic block.

In general, the brake system, particularly, an integrated brake system may include the master cylinder connected to a brake pedal, a liquid pressure generation device configured to measure a displacement of the brake pedal and generate liquid pressure, the hydraulic block having a plurality of flow paths to transmit liquid pressure, which is generated from the master cylinder or the liquid pressure generation device, to a wheel cylinder, and an electronic control unit configured to control a flow of the liquid pressure. In this case, the master cylinder and a piston pump of the liquid pressure generation device may be provided in the hydraulic block and connected to the flow path. In addition, solenoid valves are provided at appropriate positions in the plurality of flow paths to selectively allow brake oil to flow. Therefore, the electronic control unit performs a braking operation by controlling the flow of the liquid pressure to be transmitted to the wheel cylinder by adjusting the solenoid valves.

Because the integrated brake system is a technology already publicly known widely, a detailed description thereof will be omitted.

The main reservoir may be mounted on the hydraulic block or the master cylinder and supply the brake oil to the master cylinder and the piston pump. In this case, the main reservoir may receive the brake oil from the remote reservoir 10.

Meanwhile, the remote reservoir 10 is configured to supply the brake oil to the main reservoir. Therefore, the remote reservoir 10 may be provided to be spaced apart from an upper side of the main reservoir at a predetermined interval.

As described above, the main reservoir and the remote reservoir 10 are provided to be spaced apart from each other, such that the main reservoir and the remote reservoir 10 may store and supply high-capacity brake oil in a limited space in the vehicle.

The main reservoir and the remote reservoir 10 may be connected by a connection member.

The remote reservoir 10 is mounted on the structure 20 of the vehicle. When the hydraulic block or the master cylinder is mounted in the vehicle, the main reservoir mounted on the hydraulic block or the master cylinder is fixed to the vehicle, but the remote reservoir 10 is mounted directly on the structure 20 of the vehicle. The structure 20 of the vehicle on which the remote reservoir 10 is mounted may be a frame of the vehicle positioned in an engine room.

The remote reservoir 10 according to the present embodiment includes a reservoir body 100 having a chamber configured to store the brake oil therein, an oil injection part 200 provided at an upper front side of a reservoir body 100 and configured to inject the brake oil, a connection port 300 provided on the reservoir body 100 and configured to supply the brake oil to the main reservoir provided to be spaced apart from the reservoir body 100, and a mounting part 400 coupled to the structure 20 of the vehicle.

The reservoir body 100 may define an external appearance of the remote reservoir 10 and have the chamber configured to store the brake oil therein. The reservoir body 100 may be configured by coupling an upper body and a lower body to define a space therein. The upper body and the lower body may be integrated by being coupled by thermal bonding.

The oil injection part 200 is provided at the upper front side of the reservoir body 100. Therefore, the oil injection part 200 may be provided on the upper body.

A cap (not illustrated) may be coupled to the oil injection part 200 and prevent the brake oil from leaking to the outside.

The connection port 300 may be provided at a lower side of the reservoir body 100. Therefore, the connection port 300 may be provided on the lower body. The connection port 300 is connected to the connection port of the main reservoir by the connection member. In this case, because the remote reservoir 10 is provided at a position higher than the main reservoir, the brake oil may be easily delivered to the main reservoir.

In order to deliver the brake oil in the remote reservoir 10 to the main reservoir, one end of the connection member is connected to the connection port of the remote reservoir 10, and the other end of the connection member is connected to the connection port of the main reservoir. The connection member may be provided as a rubber hose so that the brake oil may be easily delivered even though the installation position of the remote reservoir 10 or the main reservoir is selectively changed.

Meanwhile, a bottom surface of the remote reservoir 10 may include an inclined section. The inclined section may be provided to be inclined so that the brake oil flows toward the connection port 300.

The mounting part 400 is coupled to the structure 20 of the vehicle and configured to mount the remote reservoir 10 in the vehicle. The mounting part 400 includes a main mounting part 410 configured to couple the reservoir body 100 to the structure 20 of the vehicle, and an auxiliary mounting part 420 configured to couple the reservoir body 100 to the structure 20 of the vehicle before the main mounting part 410 is coupled.

The main mounting part 410 securely couples the reservoir body 100 to the structure 20 of the vehicle. For example, the main mounting part 410 may couple the reservoir body 100 to the structure 20 of the vehicle by bolting.

The auxiliary mounting part 420 couples the reservoir body 100 to the structure 20 of the vehicle before the main mounting part 410 is coupled. As described below, the auxiliary mounting part 420 simply couples the reservoir body 100 to the structure 20 of the vehicle, such that the reservoir body 100 may be temporarily fixed before the main mounting part 410 is coupled.

The auxiliary mounting part 420 not only temporarily couples the reservoir body 100 to the structure 20 of the vehicle before the main mounting part 410 is coupled, but also maintains the coupled state between the reservoir body 100 and the structure 20 of the vehicle even after the main mounting part 410 is coupled, such that the reservoir body 100 may be more securely coupled to the structure 20 of the vehicle.

With the configurations of the main mounting part 410 and the auxiliary mounting part 420, when the remote reservoir 10 according to the present embodiment is mounted, the reservoir body 100 may be primarily coupled to the structure 20 of the vehicle by using the auxiliary mounting part 420, and then the reservoir body 100 may be coupled to the structure 20 of the vehicle by using the main mounting part 410.

Therefore, the operator temporarily mounts the reservoir body 100 on the structure 20 of the vehicle by using the auxiliary mounting part 420 before securely coupling the reservoir body 100 to the structure 20 of the vehicle by using the main mounting part 410, such that the operator may couple the remote reservoir 10 to the structure 20 of the vehicle solely without an auxiliary operator.

For example, the structure 20 of the vehicle may be a structure, such as a frame of an engine room of the vehicle, for defining a body of the vehicle, or the structure 20 of the vehicle may be a structure coupled to the structure that defines the body of the vehicle.

As illustrated in FIG. 2, the structure 20 of the vehicle may include a vertical wall portion 25 and a horizontal wall portion 26. The vertical wall portion 25 and the horizontal wall portion 26 may be provided by bending a single board or provided in a shape made by coupling boards. In this case, particularly, the vertical wall portion 25 may be positioned to be closer to the front side of the vehicle than the horizontal wall portion 26 to the front side of the vehicle. However, the present disclosure is not limited thereto. The vertical wall portion 25 may be positioned at a lateral or rear side of the horizontal wall portion 26. Hereinafter, the description will be made with reference to the configuration in which the vertical wall portion 25 is positioned at the front side.

At least one bolt hole 21 may be provided in the vertical wall portion 25. In addition, a second mounting hole 23 may be provided in the vertical wall portion 25. As described below, the bolt hole 21 may be coupled to the main mounting part 410 of the remote reservoir 10, and the second mounting hole 23 may be coupled to a second auxiliary mounting part 430.

A first mounting hole 22 may be provided in the horizontal wall portion 26. The first mounting hole may be coupled to a first auxiliary mounting part 420 of the remote reservoir 10.

Hereinafter, a coupling structure of the remote reservoir 10 according to the first embodiment of the present disclosure will be described with reference to FIGS. 1 to 4.

The main mounting part 410 of the remote reservoir 10 according to the first embodiment may be coupled to the vertical wall portion 25 of the structure 20 of the vehicle.

For example, the main mounting part 410 may be coupled to the structure 20 of the vehicle by bolting.

In the first embodiment of the present disclosure, the main mounting part 410 may include a first body 411 protruding upward from an upper surface of the reservoir body 100 and elongated in a leftward/rightward direction, and at least one main coupling portion 412 provided on the first body 411.

The first body 411 may protrude from the upper surface of the reservoir body 100 and define the coupling structure with the structure 20 of the vehicle. As illustrated, the first body 411 may be elongated in the leftward/rightward direction. When the remote reservoir 10 is coupled to the structure 20 of the vehicle, a rear wall surface of the first body 411 may be in contact with the vertical wall portion 25.

Because the first body 411 protrudes from the upper surface of the reservoir body 100, the first body 411 may be integrated with the upper body of the reservoir body 100.

The first body 411 may be formed on a central portion based on a forward/rearward direction of the reservoir body 100. When the remote reservoir 10 is coupled to the structure 20 of the vehicle, a load of the remote reservoir 10 and a load of the brake oil stored in the remote reservoir 10 are supported by the main mounting part 410. Therefore, the main mounting part 410 may stably disperse and support the load because the first body 411 is formed on the central portion based on the forward/rearward direction of the reservoir body 100.

Meanwhile, the first body 411 is formed on the central portion based on the forward/rearward direction of the reservoir body 100, the oil injection part 200 provided at the upper front side of the reservoir body 100 is positioned forward of the first body 411. Therefore, when the remote reservoir 10 is coupled to the structure 20 of the vehicle, the oil injection part 200 may be positioned forward of the first body 411 and the vertical wall portion 25 and exposed to the outside. A user may supplement, inspect, and replace the brake oil through the exposed oil injection part 200.

The main mounting part 410 may include at least one main coupling portion 412 provided on the first body 411. The main coupling portion 412 is a structure to be coupled to the structure 20 of the vehicle. For example, the main coupling portion 412 may have a through-hole shape penetrated by a bolt.

As illustrated in FIGS. 2 to 4, the two main coupling portions 412 each having a through-hole shape may be provided at two opposite left and right sides of the first body 411.

In the present embodiment, the main mounting part 410 may be coupled to the structure 20 of the vehicle by a bolt 30 penetratively coupled to the main coupling portion 412 of the first body 411 and the bolt hole 21 of the vertical wall portion 25, and a nut 40 coupled to the bolt 30.

As described above, the main mounting part 410 is coupled to the structure 20 of the vehicle by the bolt 30 and the nut 40, such that the remote reservoir 10 may be securely mounted in the vehicle, and, as necessary, the operator may easily detach the remote reservoir 10 from the vehicle.

In this case, the first body 411 may be coupled to a front side of the vertical wall portion 25.

Meanwhile, in the first embodiment of the present disclosure, the auxiliary mounting part may include the first auxiliary mounting part 420. The first auxiliary mounting part 420 may be coupled to the horizontal wall portion 26 of the structure 20 of the vehicle.

In the first embodiment of the present disclosure, the first auxiliary mounting part 420 may include a second body 421 having a column shape, protruding upward from the upper surface of the reservoir body 100, and provided rearward of the first body 411, and mounting grooves 422 recessed in two opposite surfaces of the second body 421.

The second body 421 may protrude from the upper surface of the reservoir body 100 and define the coupling structure with the structure 20 of the vehicle. As illustrated, the second body 421 may protrude upward from the reservoir body 100, such that the second body 421 may be coupled to the horizontal wall portion 26 when the second body 421 is coupled to the structure 20 of the vehicle.

The second body 421 may be formed on the reservoir body 100 and positioned rearward of the first body 411. That is, the second body 421 may be formed at an upper rear side of the reservoir body 100.

Because the second body 421 protrudes from the upper surface of the reservoir body 100, the second body 421 may be integrated with the upper body of the reservoir body 100.

The mounting grooves 422 may be recessed in two opposite left and right surfaces of the second body 421. The mounting groove 422 may be coupled to the first mounting hole 22 provided in the horizontal wall portion 26.

With reference to FIGS. 2 and 4, the first mounting hole 22 may include a large width portion 22a provided in the horizontal wall portion 26 and larger than a cross-section of the second body 421, and a small width portion 22b provided at a rear side of the large width portion 22a, configured to communicate with the large width portion 22a, and having a width smaller than a width of the large width portion 22a. The first mounting hole 22 may have a ‘T’ shape as a whole by the large width portion 22a and the small width portion 22b.

The large width portion 22a has a shape larger than a horizontal cross-section of the second body 421. Therefore, the second body 421 may be inserted into the large width portion 22a from below.

The small width portion 22b may communicate with a rear side of the large width portion 22a and have a width smaller than a width of the large width portion 22a in the leftward/rightward direction. In this case, a width of the small width portion 22b may be larger than a width of a horizontal cross-section of a portion of the second body 421 in which the mounting groove 422 is formed. The width of the small width portion 22b may be smaller than a width of a cross-section of a portion of the second body 421 in which the mounting groove 422 is not formed.

Therefore, in the state in which the second body 421 is inserted into the large width portion 22a, the mounting groove 422 slides from the large width portion 22a toward the small width portion 22b, such that the second body 421 and the horizontal wall portion 26 may be coupled.

That is, the second body 421 may be inserted into the large width portion 22a of the first mounting hole 22 provided in the horizontal wall portion 26, and the mounting groove 422 may be slid toward the small width portion 22b, such that the remote reservoir 10 may be coupled to the structure 20 of the vehicle by using the first auxiliary mounting part 420.

As described above, the remote reservoir 10 may be simply coupled to the structure 20 of the vehicle by using the first auxiliary mounting part 420, and then the remote reservoir 10 may be securely coupled to the structure 20 of the vehicle by using the main mounting part 410.

Meanwhile, the second body 421 may include a hole structure 423 recessed downward from an upper surface of the second body 421. With the hole structure 423, an overall thickness of the second body 421 may be reduced, such that the contraction and deformation may be minimized and the cooling time may be reduced when the upper body of the reservoir body 100 is made by injection molding.

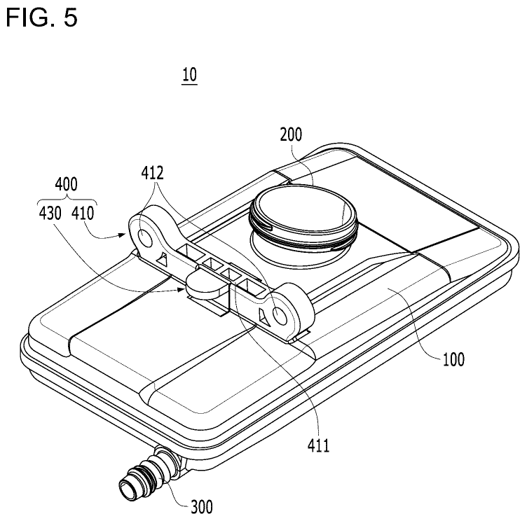

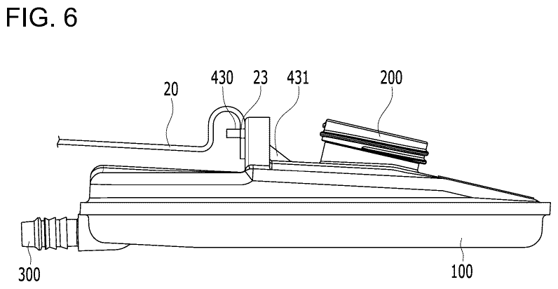

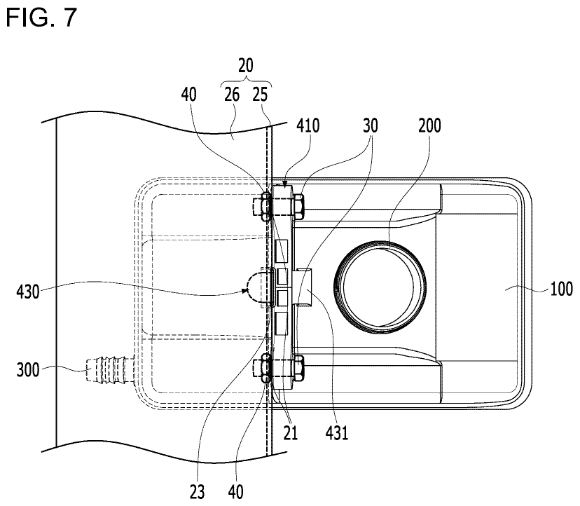

FIG. 5 is a perspective view schematically illustrating a remote reservoir according to a second embodiment of the present disclosure, FIG. 6 is a side view schematically illustrating a state in which the remote reservoir according to the second embodiment of the present disclosure is coupled to the vehicle structure, and FIG. 7 is a top plan view schematically illustrating a state in which the remote reservoir according to the second embodiment of the present disclosure is coupled to the vehicle structure.

Hereinafter, a coupling structure of the remote reservoir 10 according to the second embodiment of the present disclosure will be described with reference to FIGS. 5 to 7.

In the same way as the first embodiment, the main mounting part 410 of the remote reservoir 10 according to the second embodiment may be coupled to the vertical wall portion 25 of the structure 20 of the vehicle.

Because the structure and function of the main mounting part 410 are identical to those in the first embodiment, a description thereof will be omitted.

In the second embodiment of the present disclosure, the auxiliary mounting part may include the second auxiliary mounting part 430. The second auxiliary mounting part 430 may be coupled to the vertical wall portion 25 of the structure 20 of In the second embodiment of the present disclosure, the second auxiliary mounting part 430 may include a coupling protrusion protruding rearward from the first body 411.

As described above, when the remote reservoir 10 is coupled to the structure 20 of the vehicle, the rear wall surface of the first body 411 may be in contact with the vertical wall portion 25. In this case, the second auxiliary mounting part 430 may include the coupling protrusion protruding rearward from the first body 411 and be coupled to the vertical wall portion 25 by means of the coupling protrusion.

As illustrated in FIG. 2, the second mounting hole 23 may be provided in the vertical wall portion 25. The second mounting hole 23 may be provided at a position corresponding to the coupling protrusion of the second auxiliary mounting part 430, such that the coupling protrusion may be inserted into the second mounting hole 23.

The coupling protrusion protrudes rearward from the first body 411.

The coupling protrusion may have a shape having a width in the leftward/rightward direction, and the width may decrease rearward so that the coupling protrusion may be easily inserted into the second mounting hole 23.

The coupling protrusion may be integrated with the first body 411.

The coupling protrusion may be formed on the central portion of the first body 411 between the two main coupling portions 412.

As illustrated in FIG. 6, in order to couple the remote reservoir 10 to the structure 20 of the vehicle by using the second auxiliary mounting part 430, the coupling protrusion may be inserted rearward into the second mounting hole 23, which is provided in the vertical wall portion 25, from the front surface, such that the remote reservoir 10 may be coupled to the structure 20 of the vehicle.

As described above, the remote reservoir 10 may be simply coupled to the structure 20 of the vehicle by using the second auxiliary mounting part 430, and then the remote reservoir 10 may be securely coupled to the structure 20 of the vehicle by using the main mounting part 410.

Meanwhile, the first body 411 may have a structure reinforcement portion 431 provided between the upper surface of the reservoir body 100 and the front surface of the first body 411 and disposed at a position corresponding to the position of the coupling protrusion. The structure reinforcement portion 431 may ensure coupling stability when the remote reservoir 10 is coupled to the structure 20 of the vehicle by the second auxiliary mounting part 430.

The structure reinforcement portion 431 may have a reinforcement structure having a rib shape and provided between the upper surface of the reservoir body 100 and the front surface of the first body 411.

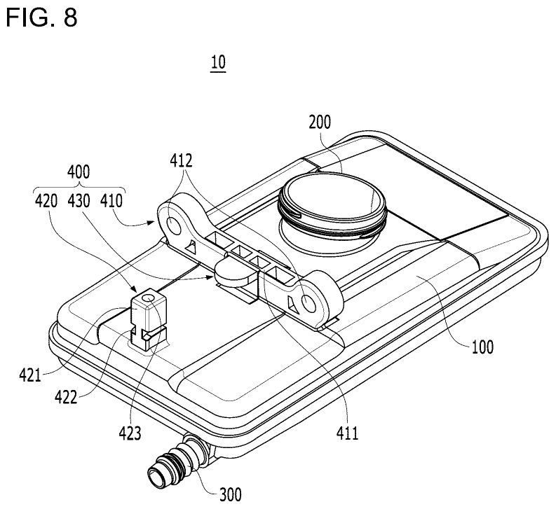

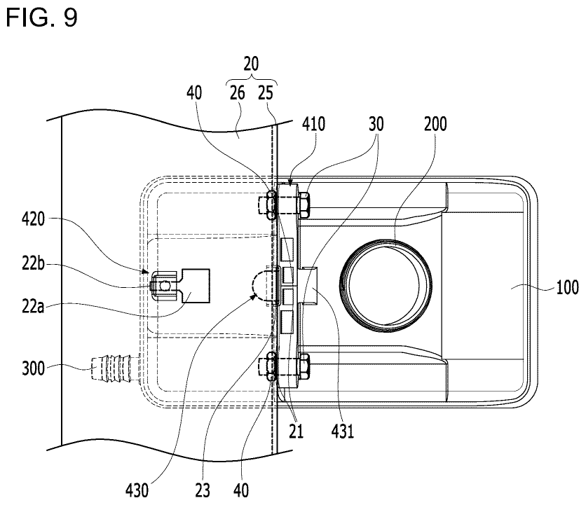

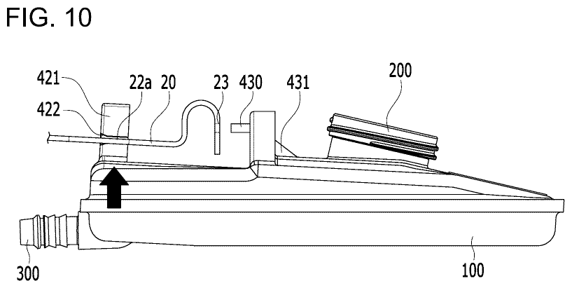

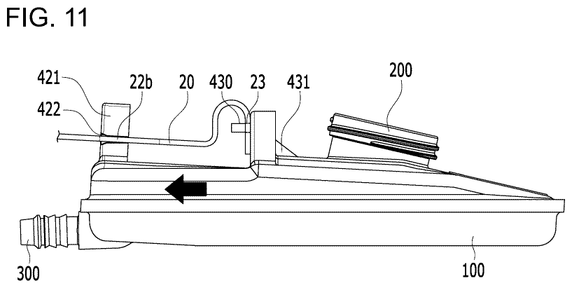

FIG. 8 is a perspective view schematically illustrating a remote reservoir according to a third embodiment of the present disclosure, FIG. 9 is a top plan view schematically illustrating a state in which the remote reservoir according to the third embodiment of the present disclosure is coupled to the vehicle structure, FIG. 10 is a side view schematically illustrating a process of coupling the remote reservoir according to the third embodiment of the present disclosure to the vehicle structure, and FIG. 11 is a side view schematically illustrating a state in which the remote reservoir according to the third embodiment of the present disclosure is coupled to the vehicle structure.

Hereinafter, a coupling structure of the remote reservoir 10 according to the third embodiment of the present disclosure will be described with reference to FIGS. 8 to 11.

In the same way as the first and second embodiments, the main mounting part 410 of the remote reservoir 10 according to the third embodiment may be coupled to the vertical wall portion 25 of the structure 20 of the vehicle.

Because the structure and function of the main mounting part 410 are identical to those in the first embodiment, a description thereof will be omitted.

In the third embodiment of the present disclosure, the auxiliary mounting part may include both the first auxiliary mounting part 420 in the first embodiment and the second auxiliary mounting part 430 in the second embodiment. The first auxiliary mounting part 420 may be coupled to the horizontal wall portion 26 of the structure 20 of the vehicle, and the second auxiliary mounting part 430 may be coupled to the vertical wall portion 25 of the structure 20 of the vehicle.

The first auxiliary mounting part 420 may include the second body 421, and the mounting grooves 422 recessed in the two opposite surfaces of the second body 421. In addition, the second auxiliary mounting part 430 may include the coupling protrusion protruding rearward from the first body 411.

The mounting groove 422 of the second body 421 of the first auxiliary mounting part 420 may be coupled to the first mounting hole 22 provided in the horizontal wall portion 26, and the coupling protrusion protruding from the first body 411 of the second auxiliary mounting part 430 may be coupled to the second mounting hole 23 provided in the vertical wall portion 25.

As described above, the remote reservoir 10 may be simply coupled to the structure 20 of the vehicle by using the first auxiliary mounting part 420 and the second auxiliary mounting part 430, and then the remote reservoir 10 may be securely coupled to the structure 20 of the vehicle by using the main mounting part 410.

Meanwhile, in the same way as the first embodiment, the second body 421 having a column shape may be inserted into the large width portion 22a of the first mounting hole 22 provided in the horizontal wall portion 26 as illustrated in FIG. 10, and the mounting groove 422 may be slid toward the small width portion 22b formed at the rear side of the large width portion 22a as illustrated in FIG. 11, such that the remote reservoir 10 may be coupled to the structure 20 of the vehicle by using the first auxiliary mounting part 420 and the second auxiliary mounting part 430 in the third embodiment.

As described above, when the mounting groove 422 is slid toward the small width portion 22b, the coupling protrusion may be inserted into the second mounting hole 23 provided in the vertical wall portion 25, as illustrated in FIG. 11.

In order to couple the mounting groove 422 of the first auxiliary mounting part 420 to the small width portion 22b, the mounting groove 422 may be slid rearward, i.e., toward the small width portion 22b, and the coupling protrusion of the second auxiliary mounting part 430 may be slid in the same way as when the coupling protrusion is inserted into the second mounting hole 23. Therefore, the coupling protrusion may be inserted into the second mounting hole 23 at the same time when the mounting groove 422 is coupled to the small width portion 22b.

According to the remote reservoir 10 according to the present embodiment, the remote reservoir 10 may be simply and primarily coupled to and mounted on the structure 20 of the vehicle by using the auxiliary mounting parts 420 and 430, and then the remote reservoir 10 may be securely coupled to the structure 20 of the vehicle by using the main mounting part 410, such that the operator may solely and easily mount the remote reservoir 10.

In addition, the coupled state of the structure 20 of the vehicle may be maintained by means of the auxiliary mounting parts 420 and 430 even after the remote reservoir 10 is coupled, such that the remote reservoir 10 securely may be coupled even though vibration occurs while the vehicle travels. Therefore, the vibration of the remote reservoir 10 may be reduced, such that a leak of brake oil may be reduced.

The present disclosure has been described with reference to the limited embodiments and the drawings, but the present disclosure is not limited thereto. The described embodiments may be changed or modified by those skilled in the art to which the present disclosure pertains within the technical spirit of the present disclosure and within the scope equivalent to the appended claims.

1. A remote reservoir, which is mounted on a structure of a vehicle, the remote reservoir comprising:
a reservoir body having a chamber configured to store brake oil therein;
an oil injection part provided at an upper front side of the reservoir body and configured to inject the brake oil;
a connection port provided on the reservoir body and configured to supply the brake oil to a main reservoir provided to be spaced apart from the reservoir body; and
a mounting part coupled to the structure of the vehicle,
wherein the mounting part comprises:
a main mounting part configured to mount the reservoir body on the structure of the vehicle; and
an auxiliary mounting part configured to mount the reservoir body on the structure of the vehicle before the main mounting part is coupled.

2. The remote reservoir of claim 1, wherein the main mounting part is coupled to the structure of the vehicle by bolting.

3. The remote reservoir of claim 1, wherein the main mounting part comprises:
a first body protruding upward from an upper surface of the reservoir body and elongated in a leftward/rightward direction; and
a main coupling portion provided on the first body.

4. The remote reservoir of claim 3, wherein the main mounting part is coupled to a vertical wall portion of the structure of the vehicle.

5. The remote reservoir of claim 4, wherein the auxiliary mounting part is coupled to a horizontal wall portion of the structure of the vehicle.

6. The remote reservoir of claim 5, wherein the auxiliary mounting part comprises:
a second body having a column shape, protruding upward from the upper surface of the reservoir body, and provided rearward of the first body; and
mounting grooves recessed in two opposite surfaces of the second body, and
wherein the mounting grooves are coupled to a first mounting hole provided in the horizontal wall portion.

7. The remote reservoir of claim 6, wherein the first mounting hole comprises:
a large width portion provided in the horizontal wall portion and larger than a cross-section of the second body; and
a small width portion provided at a rear side of the large width portion, configured to communicate with the large width portion, and having a width smaller than a width of the large width portion, and
wherein the mounting grooves are coupled by being slid from the large width portion toward the small width portion.

8. The remote reservoir of claim 6, wherein the second body comprises a hole structure recessed downward from an upper surface of the second body.

9. The remote reservoir of claim 4, wherein the structure of the vehicle comprises at least one bolt hole provided in the vertical wall portion, and
wherein the main mounting part is coupled to the structure of the vehicle by a bolt penetratively coupled to the main coupling portion of the first body and the bolt hole of the vertical wall portion, and a nut coupled to the bolt.

10. The remote reservoir of claim 9, wherein the first body is coupled to a front side of the vertical wall portion.

11. The remote reservoir of claim 4, wherein the auxiliary mounting part comprises a coupling protrusion protruding rearward from the first body.

12. The remote reservoir of claim 11, wherein the first body has a structure reinforcement portion provided between the upper surface of the reservoir body and a front surface of the first body and provided at a position corresponding to a position of the coupling protrusion.

13. The remote reservoir of claim 11, wherein the coupling protrusion is inserted and coupled into a second mounting hole provided in the vertical wall portion.

14. The remote reservoir of claim 13, wherein the coupling protrusion is inserted into the second mounting hole from a front surface thereof.

15. The remote reservoir of claim 7, wherein the auxiliary mounting part comprises a coupling protrusion protruding rearward from the first body.

16. The remote reservoir of claim 15, wherein the coupling protrusion is inserted and coupled into a second mounting hole provided in the vertical wall portion.

17. The remote reservoir of claim 16, wherein the coupling protrusion is inserted into the second mounting hole from a front surface thereof.

18. A method of mounting the remote reservoir of claim 1 on the structure of the vehicle, the method comprising:
coupling the reservoir body, which has a chamber configured to store brake oil therein, to the structure of the vehicle by using the auxiliary mounting part of the remote reservoir; and
coupling the reservoir body to the structure of the vehicle by using the main mounting part of the remote reservoir,
wherein the coupling of the reservoir body to the structure of the vehicle by using the main mounting part comprises:
penetratively coupling a bolt to a bolt hole of a vertical wall portion of the structure of the vehicle and a main coupling portion provided on a first body protruding upward from an upper surface of the reservoir body and elongated in a leftward/rightward direction; and
coupling a nut to the bolt.

19. The method of claim 18, wherein the coupling of the reservoir body to the structure of the vehicle by using the auxiliary mounting part comprises:
inserting a second body, which has a column shape, protrudes upward from the upper surface of the reservoir body, and provided rearward of the first body, into a large width portion of a first mounting hole provided in a horizontal wall portion of the structure of the vehicle; and
coupling and sliding mounting grooves, which are recessed in two opposite surfaces of the second body, toward a small width portion formed at a rear side of the large width portion, configured to communicate with the large width portion, and having a width smaller than a width of the large width portion.

20. The method of claim 19, wherein the coupling of the reservoir body to the structure of the vehicle by using the auxiliary mounting part further comprises:
inserting a coupling protrusion, which protrudes rearward from the first body, into a second mounting hole provided in the vertical wall portion when the mounting grooves are slid toward the small width portion.
